(19) United States
(12) Patent Application Publication
(10) Pub. No.: US 2014/0075317 A1
(43) Pub. Date: Mar. 13, 2014

(54) DIGITAL CONTENT PRESENTATION AND INTERACTION

(71) Applicant: BARSTOW SYSTEMS LLC, Long Beach, CA (US)

(72) Inventors: JOSEPH DUGAN, LONG BEACH, CA (US); JONATHAN DOMASIG, LADERA RANCH, CA (US)

(21) Appl. No.: 14/018,902

(22) Filed: Sep. 5, 2013

Related U.S. Application Data
(60) Provisional application No. 61/698,477, filed on Sep. 7, 2012.
(60) Provisional application No. 61/825,974, filed on May 21, 2013.

(51) Int. Cl. G06F 3/0484; G06F 3/0481

(52) U.S. Cl. CPC G06F 3/04842; G06F 3/04817
USPC 715/719

(57) ABSTRACT

System and methods for compiling and presenting digital content to a user using non-textual communication features are disclosed. A user interface may be used for web navigation, wherein the user interface displays pieces of information/content as one or more icons, such as circles, spheres, or other shapes. Such icons may have various non-textual features that can communicate to the user one or more characteristics of the information represented by the icon(s). For example, color, shade, shape, movement/animation, size, texture, and/or other depicted features of an icon may represent various characteristics, such as time period, popularity, content type, content source, or other characteristics.

### RELATED APPLICATIONS

This application claims priority under 35 U.S.C. §119(e) to U.S. Provisional Application Nos. 61/698,477, entitled COLOR-BASED INTERNET NAVIGATION SYSTEM, filed on Sep. 7, 2012, and 61/825,974, entitled COLOR-BASED INTERNET NAVIGATION SYSTEM, filed on May 21, 2013, both of which are incorporated by reference herein in their entirety and made a part of this disclosure.

### BACKGROUND

1. Field

This disclosure relates to software applications executed by computer hardware. More particularly, this disclosure relates to systems and methods of providing visual representations of digital content to users.

2. Description of Related Art

Web browser software applications can provide a mechanism for users to navigate the World Wide Web, or other web server, by retrieving and presenting web page, image, video or other types of web content. Web browsers can access various search engines, which are configured to search for information on the network and present search engine results pages comprising web content and/or links thereto in an organized manner. The organization and presentation of search results can contribute to the user experience of navigating the web.

### SUMMARY

In certain respects, colors can represent individuals' perception of the world. For example, humans can associate colors with various concepts at different levels of consciousness. Color associations can transcend language barriers. Therefore, there is a need for systematic approaches that use color as a means of representation to navigate and/or identify digital content. Certain embodiments disclosed herein provide for an efficient mechanism for producing favorable results in an otherwise relatively cluttered landscape.

In addition, color-based digital content representation can be used to match personal profiles and align a user base with like-minded individuals, venues, media and products. As an example, a user's profile may be represented at least in part by a location on the color spectrum (e.g., ROYGB), such as in the orange region of the spectrum, or other location. Aspects of the user's profile captured by the color designation may include, for example, online history, demographic information, and/or the like. By engaging, or searching out, content characterized by a different region of the color spectrum (e.g., blue), content filtering can take on additional dimensions, wherein ‘blue’ content is presented with an ‘orange’ tint, so to speak.

The present disclosure provides a system for compiling and presenting information to a user using non-textual communication features. Certain embodiments disclosed herein include a user interface that can be used for web navigation, wherein the user interface displays pieces of information/content as one or more icons, such as circles, spheres, or other shapes. Such icons may have various non-textual features that can communicate to the user one or more characteristics of the information represented by the icon(s). For example, color, shade, shape, movement/animation, size, texture, and/or other depicted features of an icon may represent various characteristics, such as time period, popularity, content type, content source, or other characteristics.

In certain embodiments, content items are specifically depicted/categorized for a particular user or group of users. For example, the features of a displayed content icon may be selected based one or more profile or other features associated with a user. The user's peer group(s) may also influence the assignment of features to content icons. For example, content consumed by one or more members of the user's peer group may be presented to the user with one or more features communicating the relationship between the content and the user's peer(s).

Content items may be documents, videos, audio files, user comments related to media, or any other type of media or information accessible over the Internet. Systems disclosed herein may provide a media content viewer/player along with an associated content/comment gallery, wherein content items may be consumed.

A user browsing the web using one or more embodiments described herein may filter content presented to him or her. For example, certain embodiments may provide functionality for a user to manually input filtering criteria. Alternatively, or additionally, the system may derive filtering criteria from user history, demographic information, and/or profile information.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIG. 1 illustrates a content gallery in accordance with one or more embodiments disclosed herein

FIG. 2 illustrates a user interface including a comment region in accordance with one or more embodiments disclosed herein.

FIG. 3 illustrates a user interface in accordance with one or more embodiments disclosed herein.

FIG. 4 illustrates an embodiment of a media player user interface.

FIG. 5 illustrates a user interface including a video timeline in accordance with one or more embodiments.

FIG. 6 illustrates embodiments of media playback timelines in accordance with one or more embodiments.

FIG. 7 illustrates a user interface including a color bar timeline navigation object in accordance with one or more embodiments.

FIG. 8 illustrates a user interface displayed on a mobile computing device in accordance with one or more embodiments.

FIG. 9 provides example spectrum representations of digital content according to some embodiments.

FIG. 10 illustrates a user interface incorporating profile representation according to an embodiment.

FIG. 11 shows a user interface that provides profile-based Internet-searching functionality.

FIG. 12 illustrates a user interface providing image-based search result presentation.

FIG. 13 illustrates a computing system in accordance with one or more embodiments disclosed herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims that may arise herefrom is not limited by any of the particular embodiments described below. For example, in any method or process disclosed herein, the acts or operations of the method or process may be performed in any suitable sequence and are not necessarily limited to any particular disclosed sequence.

Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Terminology

The term “content” is used herein according to its broad and ordinary meaning, and may include, among possibly other things, a viewable video, prose or blog, photos or drawings, or other digital information. Generally, information that can be accessed online, or over a computer network, may be considered “content.”

The term “in network” is used herein according to its broad and ordinary meaning, and may include, among possibly other things, media or information that has been viewed or referenced in a network conversation. With respect to certain embodiments disclosed herein, this information and/or metadata associated therewith may become filterable and information that is similar in some respect can be identified. “In network” may be used herein to describe content within a content ‘player’ network or limited to a specific controlled library of information. Such aspects of filtration, and how they are visually represented and navigated may allow for identification of patterns and anomalies in those patterns, may help identify information of interest to a user at a given time. In certain embodiments, multiple layers of selectable personal relevance filtration and/or time and their graphic representation and behavior in that environment (e.g., the gallery) create the information navigation environment.

### Overview

Certain features and embodiments disclosed herein may provide for qualitatively and/or quantitatively improved content presentation, identification and/or consumption. Embodiments disclosed herein may provide systems and/or methods for using a three-dimensional, affinity, desire, and/or proximity based data organization, selection, and/or network (e.g., Internet) navigation tool using colors, shapes, movement, speed, tone, distance, size and/or other visual modifications or patterns to identify, locate, participate and/or assimilate large quantities of data substantially without the use of language, reading or translation. Rapid analysis of this information may allow for increased social connectively and commercial and philanthropic activity without finical or idiomatic friction.

There is a vast quantity of information and content available over the Internet that may be of interest to users; user interest may be based at least in part on relevance of such content to a user's demographic or personality profile. In certain embodiments, locating information of interest can require substantial effort that can impede consumption and enjoyment of such information, or content. Generally speaking, identifying traits that make one piece of content more relevant to one user than the next can be a difficult aspect of media curation and/or search results solutions. For example, certain solutions simply involve some combination of scraping, hashing, and counting. However, such solutions not provide clean bounds to produce good approximate guesses based on the classification or assigned value to the most frequent attributes. By applying color values to at least two sets of variables, certain embodiments disclosed herein provide for efficient identification of substantially accurate results based on the user's current classification.

Interactions and relevance to a user's peers or peer groups may influence the effect or interest certain of particular content with respect to the user. Therefore, by taking peer relationships into account in locating and/or presenting content to a user, the user's experience with the content may be improved.

Embodiments herein may be implemented as companion media players for displaying/playing media content. The media player may provide functionality for media annotation allowing for relevant, real-time cultural cataloguing and conversation. The media player may display a ‘smart’ content stream that continuously adjusts itself according to the emotional categorization of the user's profile. The player may display a feed in real-time and allow the ability for the user to contribute his or her own content at certain places in the timeline of the displayed media. For example, a user may be able to add his or her own photo of a location that is currently relevant to the displayed video content. The photo may then be attached to the media player at the relevant frame in the video.

### Content Filtering

User Data Profiles

Various software programs/platforms provide functionality for capturing and organizing information available on the Internet. Certain Social Media websites, for example, have developed network traffic at least partly due to information gathering and distribution functionality provided by such sites. Current and/or past platforms of Facebook, Twitter, FourSquare, Instagram, MySpace, etc. (“social networks”) are examples of Social Media platforms that have had some degree of success in connecting users with one another as well as with other types of content. Certain Social Media platforms achieve such goals at least in part through compilation and utilization of user data profiles.

In certain embodiments, aspects of social media participation, web navigation, physical hobbies, location, age, interests, and/or other activity or demographic information may be combined to create a digital representation of a user. For example, a user's combined input may be compared with that of other users having similar interests or who live near the user, wherein such comparison may be used to determine content (e.g., events, commercial promotions, or other media) that may be of cultural, financial, or other interest to the user. Therefore, volumes of content items may be filtered for presentation to a user at least partially based on the user's profile data.

Filtered content may be represented graphically to the user using, for example, a software user interface, whereby colored shapes, volumes or other representations can provide filtering functionality for assisting the user in parsing relatively large amounts of information visually.

Reference Group Filtering

As a non-limiting example, a user may wish to change unhealthy habits, modify filtering criteria to be based at least in part on characteristics of a reference group. For example, a user may set a reference group to a group having characteristically healthier habits; a user may choose to do the exact opposite of, or substantially differently from, his or her existing peer group in effort to establish new patterns. For example, in the context of one or more embodiments disclosed herein, ‘opposite’ action/information may refer to accessing information that is substantially unlike, or least like the information being consumed based on its position on an axis, and its graphic representation in a coordinate system. These healthy patterns will be identifiable, and by cross-referencing the habits of the healthier group, the user may be able to find support, as well as identify people and products that have helped others very much like him or her to achieve desired lifestyle practices. The specific community that may be of assistance may be visually highlighted in some manner.

### Non-Textual Information Representation

In certain embodiments, by using colors, shapes, sizes, speed, proximity, sound, and/or light, a user, or “web user” may be able to identify certain characteristics of a piece of content substantially immediately. Although certain features are disclosed herein as “non-textual,” it should be understood that such features may include some amount of text or other symbol, such as, for example, letters, abbreviations, trademarks or trade names, or combinations thereof.

Content Icons

In certain embodiments, digital content icons may be represented using digital icons or other representative images (e.g., thumbnails, etc.) For example, spheres or other shapes or symbols may be displayed, wherein the configuration or characteristics of such icons serve to at least partially describe digital content represented by such icons. In certain embodiments, by selecting an icon, a user may be linked to content represented by the icon, or additional metadata or information associated with the represented content may be presented to the user.

Color Coding

Colors may play a significant role in the navigation of information according to embodiments disclosed herein. Color may provide for expression beyond language, thereby allowing for communication that is not necessarily language-dependent; users who speak different languages may learn and comprehend such color-based communication independently of their respective languages. Colors may be used as a substantially non-specific, arbitrary filtration and/or group identification system. Example color associations are listed in the table below in Table A. Although certain color definitions are provided in Table A, it should be understood that any desirable color definitions may be used.

TABLE A

| Color | Definition |
|---|---|
| Navy blue | From Facebook friend |
| Green | Recent |
| Light blue | From a Twitter follower |
| Red | From a YouTube conversation |
| Orange | Video-related conversation |
| Black with red | Branded CNN conversation |

Color, color combinations, and/or variances in appearance may be key aspects of personal and group filtration as well as information identification. In certain embodiments, colors are related similarly to how they may be found or used in nature or in the physical world. For example, shades may indicate relevance (e.g., red is hot, orange is warm, blue is cool). Such language may be adaptable by a user and/or his or her reference group. The spheres and comment bar portions shown in certain figures described herein may vary in color.

In certain embodiments, information and/or how it appears in the gallery is based on color. Color may indicate how others or the user have filed or filtered the same or similar information and may allow the user to navigate and select information and participate with communities that have information or experiences the user might find helpful, useful or entertaining.

Rather than ‘rate’ media consumed or evaluated with a separate process, the send bar for comments may be extended and contain a color spectrum, customizable by the user, wherein the spectrum of colors communicate different feelings, for example. Rather than, or in addition to, ‘rating’ the comment, media or information, the comment thumb 242 may simply be ‘dropped’ into the send bar 220 where the user feels. The comment send bar 220, and/or other features of the UI 200, may be movable/resizable within the UI, or may be popped-out from the UI as a separate UI. Some sites may wish to at least partially corral their comments and keep a ‘curated’ gallery for their participants. An individual user might want one or more of the features of UI 200 located on his or her desktop, or on a mobile device. Color therefore, may become a personal filing system of sorts.

Color-based filing/multiple-filtration functionality may allow for color filtration across multiple criteria, communities and groups. Such color-based communication may develop into slang over time, and exit beyond language to pass visual information across cultural and physical frontiers or borders.

Color may be considered a universal language. However, color has subtitles within cultures and sub groups. By allowing users to ‘classify’ or ‘file’ or ‘rate’ consumed information by color, a user may be allowed to utilize an esoteric search option that works on an intuitive level rather than one based directly on logical or liner thinking. This coding may then link seemingly unrelated concepts ideas or pieces of information or media and allow them to be found by users who can find that information useful in some way.

In certain embodiments, color assignment is based at least in part on some or all of the following associated logic: Traits/characteristics/words likened to beauty, love and/or safety may fall in the red/orange spectrum. Happiness, peace, health and/or good fortune may fall in the yellow/green areas of the spectrum. Words associated with energy level, such as from calm and healthy to dizzy, cranky and drained, may fall in the green/blue area of the spectrum. Traits/words representative of more “active” emotional characteristics, including possibly words associated with sex, passion, anger, sadness and/or pain may fall in the blue/purple/red region(s) of the spectrum.

Thought of like a recipe, the addition of grey to a hue seems to imply an element of confusion or shame. Words like isolated, embarrassed, weak, lonely, worried and selfish may be placed in the grey-er color valued areas of the spectrum as adjunct emotions to more readily expressed happy/sad, yellow/blue etc. Words like depressed, suicidal, fury, ugly, dirty, alone and awful—which seem to express a more terminal fear, anger or doubt—are placed in areas of the spectrum containing more black.

The following examples demonstrate how non-textual features may be used in an embodiment, wherein the particular features are called out in parentheticals for illustrative purposes:

### EXAMPLE 1

A large (size) blue and green (color) sphere (shape), with an bold orange ring (visual feature) around may indicate, for example, that information represented by this ‘dot’ (e.g., sphere) was viewed by on one or more of the users' Facebook friends, or Twitter followers had viewed this information recently, and/or people who live near the user are consuming this information. The terms “user” and “web user” are used herein according to their broad and ordinary meanings, and may include, among possibly other things, a first-person accessor or consumer of information or media using a user interface as disclosed herein.

### EXAMPLE 2

A small (size) green (color) dot (shape) without an orange ring or a shaded (shade) blue surface would indicate a piece of information with some relevance was viewed recently; however, the content not been viewed or consumed by the user's social media community, and is not of specific importance to the local community. By combining information in different visual elements, it may be possible for the user can identify relevant, or relatively more relevant, information rapidly.

### EXAMPLE 3

An orange (color) sphere (shape) may represent a comment in a conversation, a blue (color) ring (shape) around that may indicate it was made by a Facebook friend of the user, a pulsating (animation) green (color) ring (shape) may indicate it was made recently.

Visual features of the system may take any conceivable configuration or color, depending on design preferences. Changes in colors, patterns, etc., may allow the user to ignore or disregard information that does not meet sufficient personal criteria for him or her to view.

The relevance of content to the user may be sufficiently clear, though his or her decision on which information to consume may be based on his or her current circumstances. For example, current physical needs in time of the user may serve as at least a partial basis for consumption decisions. Should the user be interested in dinner in an unfamiliar city, certain embodiments may include an interface providing access to a map populated by spheres, or other shapes, of eating opportunities filtered in any number of customizable ways.

### Content Gallery

Certain embodiments disclosed herein provide for a user interface content gallery feature, which provides a box, window, or other graphical representation of a region in which icons representing digital content items may be displayed for consideration by a user. The icons may represent various types of digital content, such as, for example, text files, video files, audio files, image files, webpages, comments associated with media or other content, advertisements, social media posts, or other types of digital content. In certain embodiments, by selecting an icon in the content gallery, the system may be configured to cause the content to be downloaded by to the user, or the user may be linked to a content source server. Furthermore, the gallery may be configured to provide additional metadata associated with content items in response to an action by the user, such as by hovering over an icon or otherwise indicating a desire to view additional information associated with the content represented by the content icon.

In certain embodiments, advertisers or other content providers may pay only for the galleries they populate, and receive compensation for the content pieces of theirs that are clicked and/or utilized. For example, in certain embodiments, video content would be red, friend comments about San Diego in blue, and advertising would be pink, thus reducing the ‘surprise factor’ of adds. Furthermore, in certain embodiments, the filtration of the adds a user is exposed to are pre-selected, directly or indirectly, by the user; based on the appearance of representative content icons, the user may be able to make an educated decision to participate in certain content, and ultimately products or services associated with such content. In certain embodiments, the size of a content icon (e.g., dot) can indicate added relevance, such as indicating how current, or immediately relevant to, for example, a current search, location or other factor, a piece of content is.

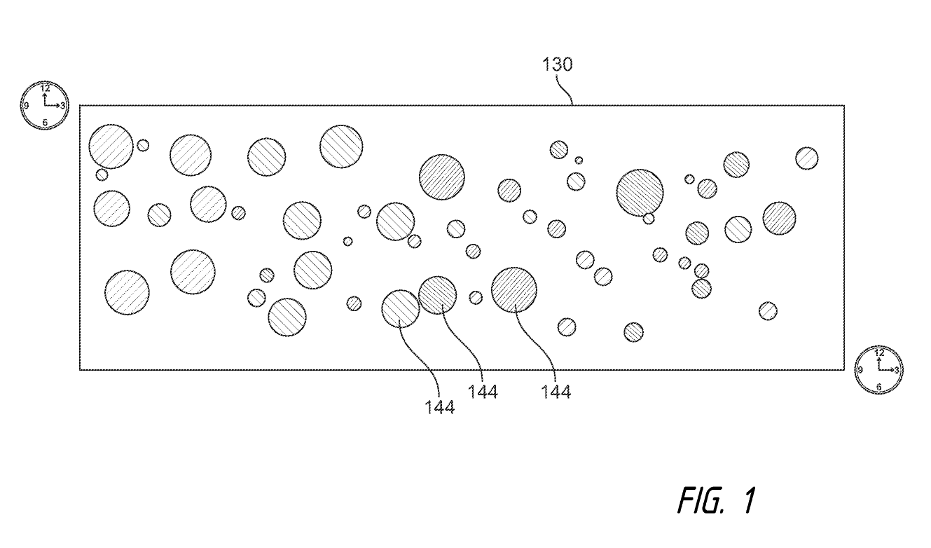

FIG. 1 illustrates a gallery 130 including content representative icons 131 in accordance with one or more embodiments of the present disclosure. As shown, the icons 131 may comprise sphere-shaped icons, and/or may comprise other shapes. Icons may be represented as 2-dimensional and/or 3-dimensional shapes, or combinations thereof.

A relevance gallery, such as the gallery may select content for presentation based at least in part on past digital activity of, whereby pieces of content that appeared at one time in the user's gallery may be recycled and re-referenced in accordance with the navigation pattern of not only the user, but possibly the user's community as well, and/or the communities of other users. For example, the metadata associated with the information accessed in the past may be compared with data accessed currently by the user or the user's reference group to determine if it has a new relevance, and may reappear or trigger another piece of information to appear in the user's gallery. In certain embodiments, upon ‘mouse-over’ or other initial selection of a content icon, similar icons/content may gravitate towards the selection, thereby at least partially isolating/separating the content from other content in the gallery.

In certain embodiments, as described above, filters define the contents of the gallery. Filters may be selected by the user to give him or her access to particles of information relevant to time place and activity as well as esoteric aspects including varying degrees of community segmentation and participation in information, or product consumption or physical activity.

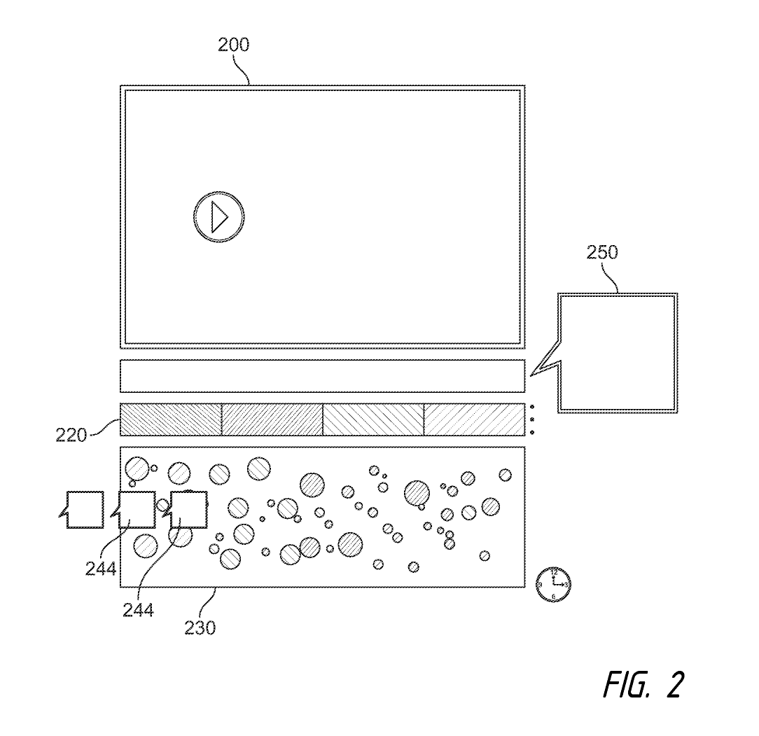

FIG. 2 illustrates a user interface (UI) 200 including a comment region in accordance with one or more embodiments disclosed herein. The UI 200 includes a gallery 230 for presenting/recommending content to a user. The gallery 230 may be designed to adaptively modify the content that is presented. That is, the system may be configured to ‘learn’ to provide directed content as more information is made available. For example, the gallery may begin with limited content, such as generic search results, until directed content is generated based on information derived relating to the user is some way. The UI 200 further includes a comment box 250 that may provide functionality for inputting comments or other content in association with media presented in a window of the user interface.

A user may allow a content source (e.g., advertiser, magazine publisher, manufacture, artist, employer) to populate his or her gallery once the information they have to contribute has been deemed useful or interesting by the user. This ‘permission’ may be granted for a short period of time, or an individual search. For example, if a user was to go on vacation to San Diego, he may want to populate his gallery with San Diego-related information for the period of time he/she is researching the adventure, as well as possibly during the trip. An advertiser, travel group or niche market might offer the best concentrated information for that particular user at that time, and therefore, the user may choose to filter gallery contents in association with such entity/market. Upon return to home, the user may de-activate such filtering from populating his/her gallery.

As described above, a gallery may display icons representing user comment content. Comment content may be associated with digital media, such as a video or audio file, or a news article, or the like. For example, a web page may include a media player/display plugin, wherein content is displayed using such plugin. The webpage may further or alternatively include a comment plugin, wherein the plugin provides a gallery that displays comment data. The user may peruse the icons displayed in the comment gallery to help identify comments of interest to the user. Certain embodiments described herein include various comment-related features and functionality.

### Comment Timeline

Comments may appear, and/or may be made in ‘real time’ during content presentation according to one or more embodiments of the present disclosure. For example, certain embodiments may provide a user interface configured to present media content, or the like, wherein user comments are associate with the content.

With respect to video and/or audio content, the user interface may be configured to present comments in temporal connection with the portion of content with which the comments are associated. For example, the user may cause the content to be planed; comments may be represented as “text+”, or in some other manner, and appear in the ‘comment box’ as the content plays. As used herein, “text+” may refer to blogs, news text, image and/or video links that can be attached to a comment to provide reference and further communication, or other types of content presentation medium.

In certain embodiments, comments appear as the media moves along. Content spheres (or other shapes) may interact by being visually represented at the point in the media the comment refers or relates to. For example, a sphere representing a comment at 00:10 in the media may be larger and/or closer to the ‘surface’ when media approaches and/or hits the 00:10 mark. At 01:24, the 00:10 comments graphic representation may be much less viewable, perhaps invisible/dormant.

In certain embodiments, filtering comments by region, feeling, interest, social media and/or network overlay as well as frequency and/or position may allow for a user to engage in educated forays into topics and surrounding information. Filtering may be accomplished in a number of ways, depending on design preferences/requirements. For example, filtering may be performed by the system automatically based on profile or historical data, or may be done through manual selection, or a combination of both. Depending on the objective of the relevant host site, the filter system could be provided for the user by the host.

In certain embodiments, content results are based on the number of matches produced from a profiling scrape operation, which may produce a results spectrum, such as a spectrum including the top three matches found within the content pool.

In an embodiment, a user profile produces a combination of 6 color swatches represented as follows: Personality Type—Cumulative Trait results—(1 swatch); Trait Type—Characteristics results—(2 swatches); and Trait Children—Top 3—(3 swatches). Using such classification, the system may be able to construct a substantially subjective, self-adjusting stream of media content. A “current emotional state” may serve as a point of origin, and may be assessed by scraping the initial query media for emotional context cue words and laying them over an associated color spectrum. From there, moves may be profiled and assigned an emotional color-grade used to identify, cross-plot, and adjust the stream. By assigning a weighted value on an axis of, for example, emotional vs. intellectual and/or theoretical vs. experiential, the system may be configured to establish a median to determine a score for each piece of source content. Interaction may be measured against the most recent interaction(s) to determine a current state or profile. A user profile may be measured in a substantially similar manner as an article, while pulling from a cumulative list of traits.

When the weighted value is cross referenced with a query, more accurate results may be achievable. For example, when a user having a history of adventure, the system may be more inclined to recommend a mixed-type (e.g., love/hate) reviewed Thai restaurant that people have had similar emotional responses to. Further, if a user interacts with content, such interaction may affect the user's profile as well. For example, a generally mild person may express passion about a particular topic and unlock a wealth of insight about their character normally unturned by digital methods.

### Comment Function/Connectivity

Comments can provide a user access to communities, and groups of interested participants who share similarities with him or her. In certain embodiments, users are able to view and participate with commenters' media history, and if necessary or desired, make contact with them, become part of their community, and/or initiate dialog with them. For example, participation with a commenter or commenter content may allow for linking to relevant media/content. Once accessed, metadata may be attached to a user's filtration, allowing potentially relevant data to surface. In certain embodiments, such functionality is implemented as a desktop widget and/or mobile application.

In certain embodiments, when selecting a comment, the user may have access to one or more of the following: (1) Other media the commentor has commented on; (2) other media others have made a similar or not similar comment, as well as access to their library of consumed media and commenting community; (3) comments from others in your region; (4) comments or commenters from outside the user's region but with relevance to the associated content; (5) content consumed (e.g., viewed or accessed) by specific members of the user's online community. Should a user participate in the conversation, his or her comment and references may ‘carry’ the existing conversations with it.

In an example use case, a user is watching a movie about surfing and at a certain point in the playback he recognizes a beach he previously spent a family vacation at. The user may be able to attach his narrative to that media in context. Attaching photos and videos to that point in playback allows the next user to have a richer experience in view of the first user's contribution. Such functionality may also allow content trees to grow in infinite, or substantially many, directions. Other users that have had similar experience can carry the conversation in any direction they like with their social audience. Color or other non-textual communicative tools may allow for the ability to filter out the narratives to pieces only of interest to a particular user based on the user's profile. As another example, users may view a presidential debate using a content presentation window and/or content gallery, as described herein. A user having political preferences on one side of the political spectrum may be able to filter out comments and content sources from individuals/entities that are profiled as having different political views. The user may thereby be able to more easily engage in meaningful interactions with like-minded individuals, wherein color and/or other non-textual characteristics allow for quicker, easier identification of the same.

Cross referencing (e.g., filtering the results of multiple search criteria) and color coding the results of ‘comment’-related information may allow for the comment and related information to be represented as a sphere (or other shape) of color, who's size, and visual patterns can allow for identification of content relevance with respect to other pieces of information on related topics or of discussion within a user's various communities.

While a certain piece of content may be represented one way for one user, the came content may be represented in an at least partially different way for another user. For example, content that is presented as a large, glowing orb in one user's gallery may be non-existent in another user's gallery. The term “gallery” is used herein according to its broad and ordinary meaning, and may include, among possibly other things, a defined area in which graphically represented information or media can be accessed. In certain embodiments, relationships of content items across filterable criteria may be viewable in a gallery.

### EXAMPLE 4

As a non-limiting example, if User A enjoys classical music, lives in the Canadian North, and owns a pack of sledding dogs, pieces of content related to dog sledding, Cold weather, and staying warm would may appear more frequently and in a more obvious, conspicuous visual fashion than pieces of content relating to sandals, for instance.

When User A searches for sandals, however, his community may be activated, and results (e.g., internet search results) may become cross referenced with some or all of the following information: Sandals his social media community has used; where they have used them; reviews on other sandals; possible vacation destinations; where to buy sandals nearby etc.;

Filtering functionality may be implemented to assist in identifying personally relevant or interesting data. Depending on the objective of the relevant content search, the user may be more or less motivated to participate in the filtration of the results. Therefore, it may be desirable for the system to allow the user to passively provide information that may at least partially form the basis for content filtration. Furthermore, subsequent filtrations may allow more relevant suggestion and/or deeper penetration within the community related to a particular idea, concept or product.

A user may have the ability to more accurately judge the effectiveness of a product, or content, with respect to himself or herself, as well as become connected and learn from others outside his community who have more specific knowledge of the subject at hand. For example, if a user performs a search for art directors, a system may provide art directors that appear most in emails between the user's friends, art directors mentioned on the user's social media networks and friend communities, art directors whose work appears in the films the user has watched or likes, art directors whose work appears in websites visited by the user, and/or art directors having other connections to the user or the user's online profile/history. Such a filtered group of results may identify individuals with knowledge specific to the user's reference group and/or professional or leisure activities.

Comment/personality-based filtration may allow for the user to engage with communities regarding new topics and select information based on a variety of data represented visually by color, shape size etc. Animating such data, and allowing for free flowing filtration, may push relevant options toward the information seeking user. In certain embodiments, the user may not have to identify every piece of information desired. For example, users may not be fully aware of the information they are searching, just that it should be nearby. In this way, the chances of identifying and consuming information relevant to a user's journey, life, social or business path may be improved.

### User Comment Exportation

In certain embodiments, if the user wish to comment on a piece of media or content, he or she may simply click the timeline to place a ‘comment thumb’ on the timeline, as illustrated above as call-out boxes 244 in FIG. 2. In certain embodiments, a comment thumb may be pinned to the timeline where the activity takes place, wherein the comment only becomes active when the user views the content. As an example, if the user wants to comment three times on a specific media item, he or she may find three windows waiting for them at the end of the media, (e.g., 244 as shown in FIG. 2).

Comment thumbs may include one or more of the following features: (1) A thumbnail, or other type of icon, at the place on the timeline the activity commented on takes place, or a video frame grab exportable to social media with meta data as well as reference; (2) reference commentary, such as including, for example, the original comment, as well as the filtered community involved; (3) reference-sharing functionality, which may provide a new link that illustrates the commenter's point of view, a photo, and/or a link to other web content, site or blog to further expand the point of view or information available to related communities; such content may be attached to a comment by a commenter or other user; and (4) exportation options, providing functionality for a comment to be exported to Facebook, Twitter, Instagram, and/or the like. For example, the selected thumbnail may appear on Instagram as a posting, on Twitter with a link, or on Facebook with the comment thumbnail.

When comment thumbs are shared, they may be active and drive the viewers from their preferred social media outlet to the comment player to view the updated information and perhaps participate in information that is now relevant. The thumb may be exported as social media to ‘Instagram,’ as a Twitter message, etc. The graphical user interface may allow the user to filter through communities; in certain embodiments, the viewer can see not only the other users consuming information, but the communities and conversations around those activities and individuals. Outside participation in an idea or concept can allow for identification of patterns that separate personally valuable information.

Sharing functionality may allow for communities to participate in a variety of media formats and social media platforms, even across platforms. Photos, videos, news postings and/or physical events and media assets may further the filter mechanism, eliminating potentially time-consuming searches.

### Modularity

A comment export module may be a modular information-mining and distribution module. By containing multiple layers of detailed filtered information regarding pieces of content, such a ‘portable’ information module may be configured to exist on the cloud and allow for accurate personal filtration based searches at any time from any compatible device. For example, the portable information may be in the form of a software widget, webpage and/or mobile application.

A piece of content can be referenced and ‘dropped’ into the spectrum send bar, thereby being input into the system. Once in ‘system’ or network, the information may be compared to the user's personal histories. For example, the information may be compared to the information previously consumed, and crossed referenced with the interaction people in the user's community may have had with that information. The information may be compared using a variety of personally-chosen criteria, and begin to show information patterns and allow the user to make navigation decisions based on the intersection of information on his personal matrix (e.g. content gallery).

### User-Generated Content Posting

Certain embodiments provide for posting of user-generated content (for example, comments, photos, videos, and the like) via web or mobile device to a specific time code in a hosted online video. User-generated content (for example, comments, photos, videos, etc.) may be organized, aligned, tagged and/or displayed with a specific time code in a hosted online video. Such functionality may allow viewers of video content (both mobile and web) to contribute media to a specified time code or moment in a hosted video to tell their side of the story. This may provide an accurate point of reference for another viewer to join the conversation and consume more relevant content while providing the opportunity to connect like-minded individuals through their common engagements. Furthermore, certain embodiments provide for exportation of the time code, providing the ability to link user-generated media back to a specified time code in a hosted video. For example, if User A shares their post via Social Media, when a viewer clicks the social posted link, the viewer may be directed to the specific moment in the video that User A is referencing.

### Digital Content Presentation System

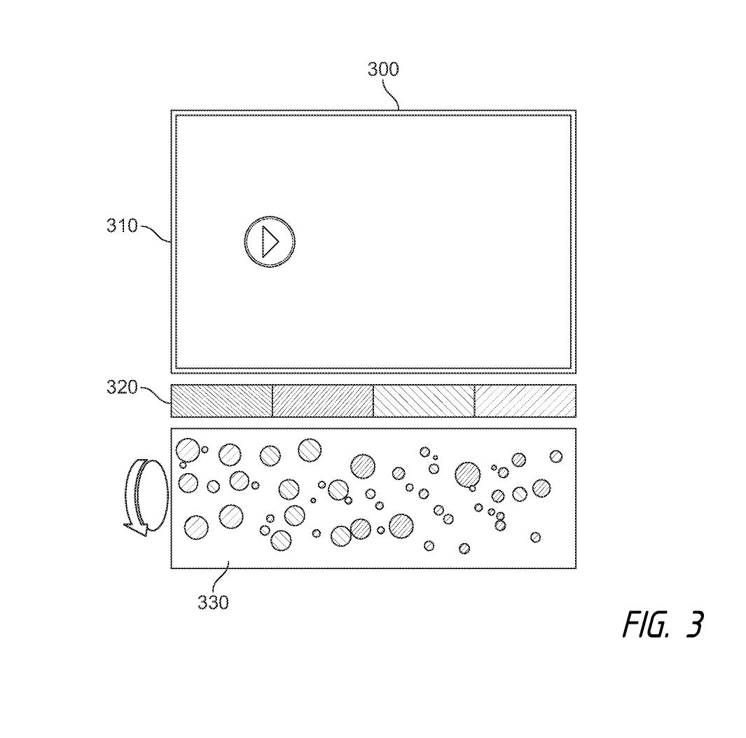

FIG. 3 illustrates a user interface (UI) 300 configured to present digital content according one or more embodiments of the present disclosure. Certain embodiments may allow individuals and/or communities to participate in conversations through media such as video. These conversations may be presented to the user through comment dialogs in a time-dependent timeline and/or a gallery of spheres to represent these comments.

A gallery 330 may be a visual interface consisting of spheres, colors, and/or movements that may help the user engage not only in the conversation of the topic media but in relevant information gathered through such outlets as social media, blogs, forums, q&a, etc.

Certain embodiments may consist of three or more major modules, including a comment module, a timeline module, and a gallery module, that may be used individually or as a group. These modules may be created with the intent that they can be plugins, such as browser extensions, to be used universally by the public. This may allow mass inception and/or ease of integration.

The comment module may allow users to enter comments through an interface which may allow users to attach/upload a media associated with it. A color box may be used as a submission mechanism to allow a more unique or arbitrary way of entering the comment.

The timeline module 320 may allow comments to be imputed based the video's time. A queue may allow users to input multiple comments without pausing the video. The timeline may show the comments associated with the media. Colors may be represented in the timeline based on comments and/or the video frames histogram.

The gallery module 330 may be a visual user interface, wherein shapes (e.g., spheres), colors, and/or movement are utilized to organize information. Generically, information may be described in the gallery when presented and interpreted in an intended manner. In regards to the system, the information displayed may be comments and/or any information crawled/indexed by our systems.

The UI 300 may include a digital content presentation window 310, such as a media player. In certain embodiments, the window 310 is configured to play video and/or audio content, or any other type of multimedia content. The UI 300 may further include a relevance gallery 330 in accordance with one or more embodiments disclosed herein. In certain embodiments, the gallery guides users with shapes and colors.

In certain embodiments, the UI 300 is provided by a digital content distribution platform, wherein content contributors are permitted to use the platform as a mechanism for distributing media content online. For example, content contributors (e.g., artists) may be able to upload content associated with a distinctive URL. Alternatively, or additionally, the UI 300 may be operated by a server, wherein content displayed in the presentation window 310 is hosted by the server.

In certain embodiments, comments, as well as other relevant or non-relevant information can be represented in the gallery 330. Such sortable, filterable search platforms may troll for information, identify potential relevance to a user, and allow for the user to choose the content most valuable to him/her at a given moment based on the relationship of the content to other information and/or usage by other users. Providing users modifiable filters may allow him/her to make choices that define him/her. Use of the ‘communal’ memory may provide situational awareness.

Information can have an aspect or degree of coincidence or chance. In certain embodiments, when visually identifiable pieces of content are animated and placed in a gallery, the results of the search may be directed, yet coincidental.

Colors, shapes, sizes, patterns and/or speed may work to identify otherwise hidden similarities, relationships and connections, and may indicate why previously-overlooked information may now be worth consuming, even if it was not on considered by the user for searching at the time searching was undertaken. For example, the gallery 330 may be populated with visual icons representing comments or other content items related in some way to content presented in the presentation window 310 or to profile characteristics of the user.

In certain embodiments, the UI 300 includes a timeline feature 320 configured to represent a play time associated with media content presented in the window 310. In certain embodiments, one or more dimensional axes of the timeline 320 and/or content gallery 330 represent time in some manner, and may provide navigation routes to find information related and unrelated to the subject searched or accessed based on visual position on, for example, the Z-axis of a Cartesian coordinate system.

Certain Internet searches can be used as direct, cause and effect, tools. Life, or discovery, outside of Internet searching, one the other hand, can differ in character in certain respects. For example, individuals may indicate they are joyful when they are stimulated by something they did not previously know they had an interest or affinity for (e.g., surprises, coincidences). Therefore, it may be desirable for digital content-searching experiences to similarly incorporate aspects of surprise and/or coincidence in some manner. To such end, the gallery 330 may be configured to identify affinity-based information and bring it to the user's radar in response to accessing or consuming, by the user, of media content. Thus, always laying out flight paths for the user to consider, even though he has just ‘touched down.’

In certain embodiments, once a piece of content is located and/or identified, it may be considered an intersection to some degree of what a user currently knows, what the user knew previously, and what the user might want to know. Selecting and refining search criteria and personal profile dynamics may provide a system that can at least partially predict what goods, services, products, or entertainment or information a user would need/want in a given time and/or place. The user may have a choice to act on the information compiled peer group experiences and navigation, or ignore it and intentionally forge ahead on his/her own.

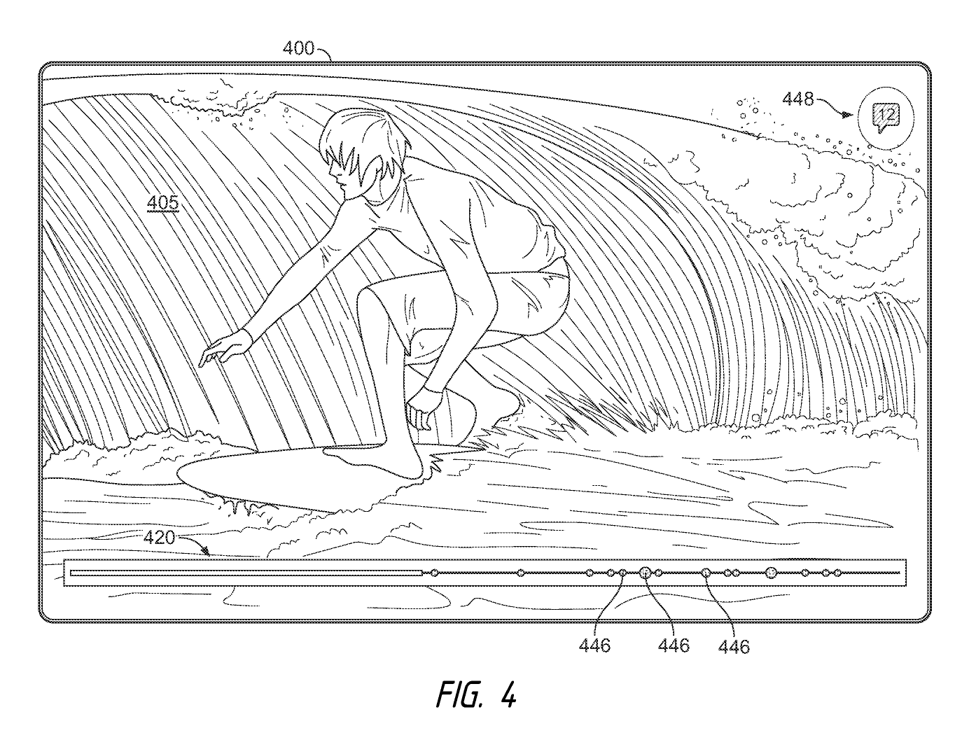

FIG. 4 illustrates an embodiment of a media player user interface 400. The UI 400 includes a media viewing window 405 and a timeline object 420, which shows the temporal position of the video (or audio) content shown in the viewing window 405. The timeline 420 further includes icons displayed thereon, or in connection therewith, wherein the icons are associated with particular points or regions of the timeline indicating the portion of the media content being displayed that is relevant to the icon. The icons may represent comments, social media posts, or the like. For example, blue spherical icons may represent Twitter tweets associated with the displayed media. The size, or other features of the icons, may be indicative of the level of activity at a particular point on the timeline 420. For example, a larger icon may indicate that a particular point or portion of the timeline 420 is associated with a relatively high concentration of user comment/social media interaction.

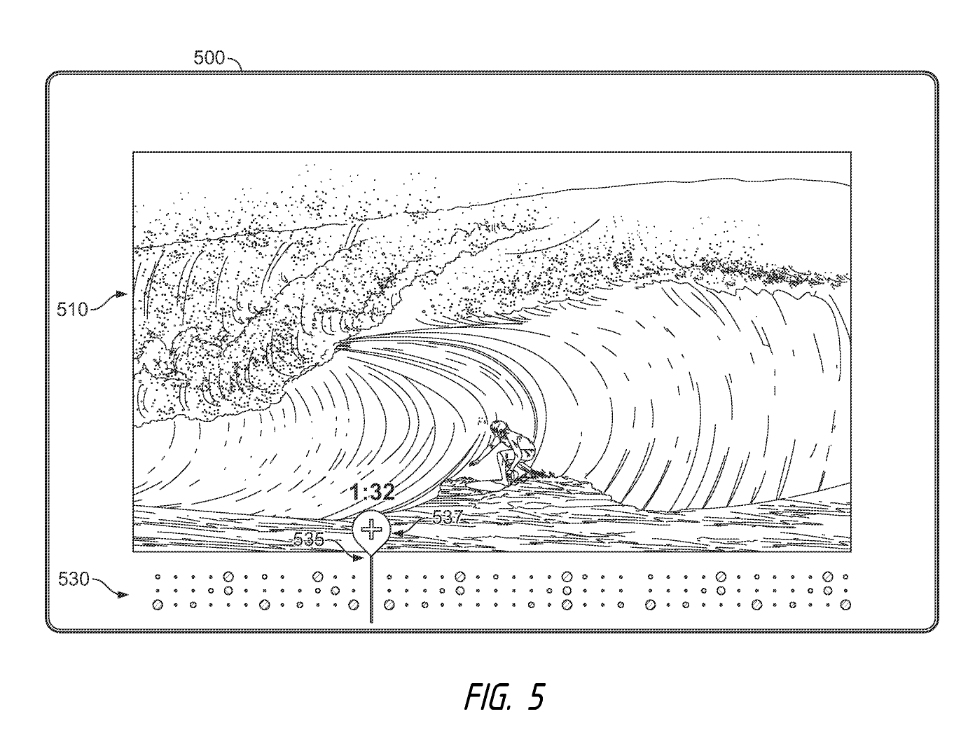

FIG. 5 illustrates a user interface including a video timeline in accordance with one or more embodiments. The UI 500 includes a media presentation window 510 for displaying, for example, video content. The UI 500 further includes a digital content display gallery 530, wherein icons associated with digital content items are superimposed on a timeline. For example, the timeline may represent the temporal span of the media content being displayed in the window 510, wherein a time marker 535 traverses the timeline from left to right while the content plays. The marker 535 may be a line or other designation representing a moment or period of time, wherein the marker sweeps across the timeline horizontally.

The UI 500 may include functionality for a user to make a comment or otherwise interact with the media content, such as by posting to social media or the like, wherein such interaction is associated with a particular point or region of the timeline. In an embodiment, an icon 537 is displayed somewhere in the UI that allows the user to initiate user media interaction my selecting the icon.

The gallery of icons 530 includes icons representing user interaction activity associated with the media content. For example, different rows, colors, or other differentiation may represent different types of user interaction or media type. In an embodiment, different colors, sizes, positions, or other differentiation may represent different social media platforms, or the like. For example, a top row (e.g., including orange icons) may represent Facebook activity associated with the media content. Icons of different sizes may be utilized to illustrate varying degrees of activity concentration. Further, in an embodiment a second row (e.g., green icons) may represent Instagram posts, while a third row (e.g., blue icons) represents Twitter posts.

By scanning the population of icons (e.g., dots) in the gallery, a user may be able to interpret the portions of media content that have elicited user response/commentary, and/or what types of user response has been generated.

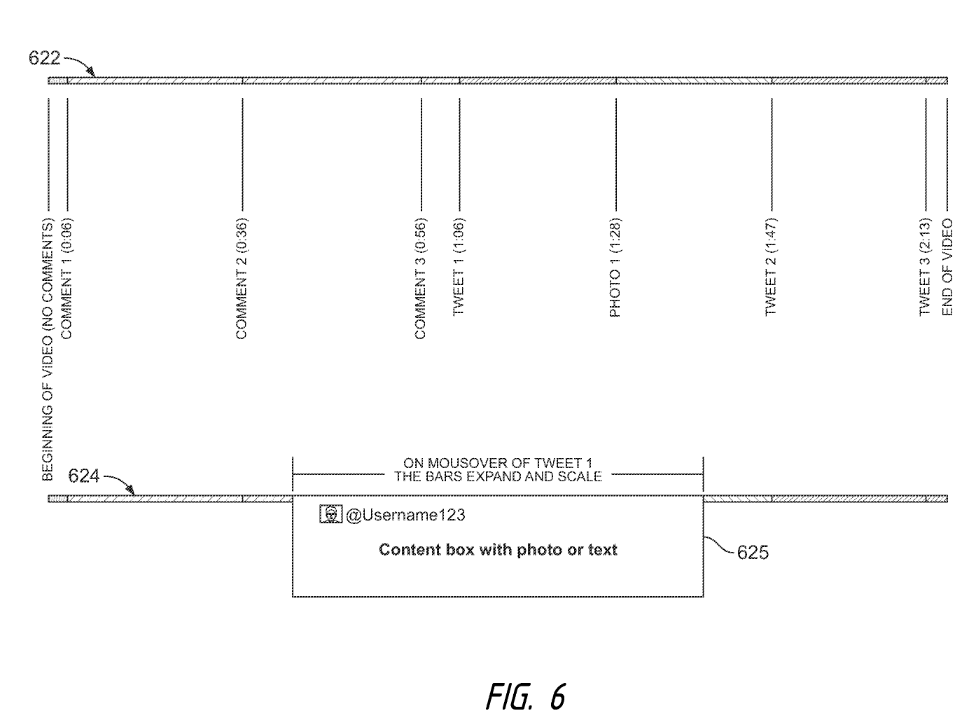

FIG. 6 illustrates embodiments of media playback timelines in accordance with one or more embodiments. The figure illustrates a media bar timeline 622. The timeline 622 may correspond to a temporal span of a piece of video or audio content, or portion thereof. As shown, comments or other content consumer interaction is represented in connection with the timeline. For example, user interaction may be represented in connection with a particular point or region of the timeline, such as by a line indicating a point or region of the timeline, or the like.

In certain embodiments, the bar 622 includes color or other defining characteristics indicating one or more characteristics associated with user comments/interaction, or with the media content itself. For example, the bar 622 may be divided up by color based on user comments/posts. When a user submits a comment/post of a particular type, a portion of the bar 622 at the point in the timeline associated with the comment/post may be colored or represented in a manner that is associated with the comment/post. For example, different types of media may be represented on the bar 622 by different colors.

In certain embodiments, rolling over a comment or portion of the timeline, or otherwise selecting, causes the comment or portion of the timeline to expand and display content associated therewith.

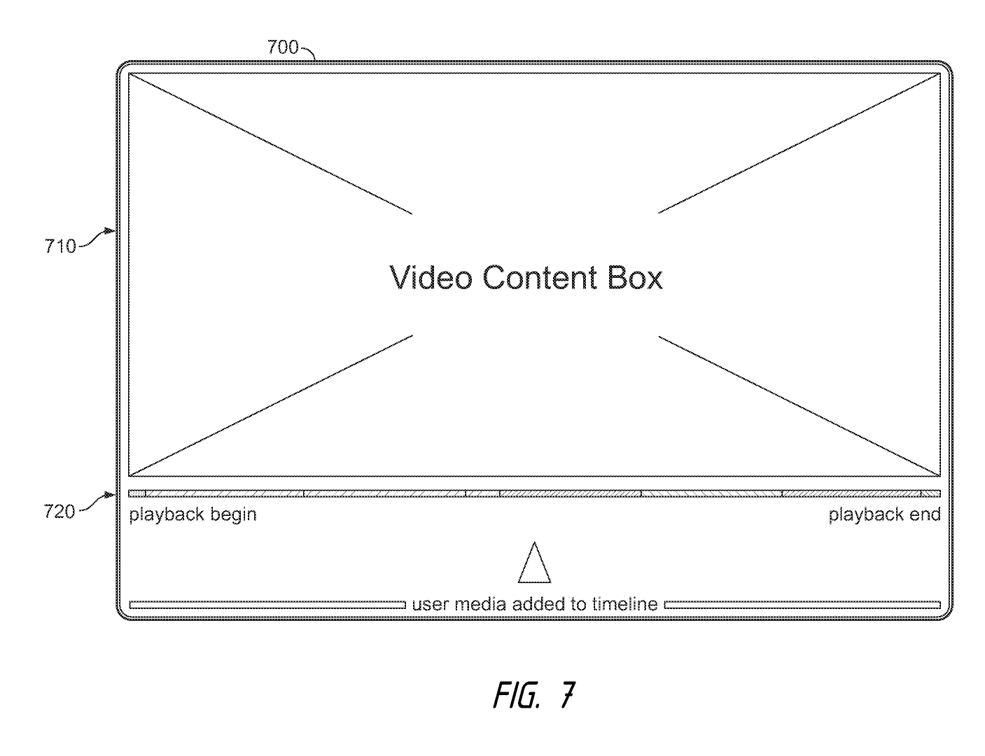

FIG. 7 illustrates a user interface 700 including a color bar timeline navigation object 720 in accordance with one or more embodiments. The UI 700 includes a media presentation window 710 for playing, for example, video content. The timeline 720 may include color or other defining characteristics that at least partially describe the content displayed in the window 710 and/or comments or other user interaction/contributions that are associated with the content displayed in the window. The user interface mm00 may further provide functionality for a user to upload content in connection with the displayed content, or a particular part or portion thereof.

### Comment/Conversation Exportation

Certain embodiments disclosed herein relate to various objectives and/or results of pattern recognition, graphic information navigation, and personal filtration and selection interface features. Such objectives/factors may include one or more of the following: Community identification and connection for entertainment, diversion, education, etc.; community identification and infometrics for advertisers and commercial concerns; and recognition of patterns and trends to combine multiple levels of information filtration to enhance personal physical experiences and discover tangential relationships and communities. For example, certain traditional relationships to metadata may be viewed as limited by the ability of the eye to recognized and read text. When the information is represented graphically, colors and shapes that are ‘similar’ may reveal relationships to related information. By using ‘dots’ or spheres, or other shapes, with coded colors, the number of visual options may substantially increase. Physical location and proximity of information to related information may reveal patterns interpretable by the user and connect people and foster communication.

As a non-limiting example, a piece of content may be viewed by a user, be it textual, video, photographic or a social media post. Below or alongside this media, a gallery, or “gallery of relevance” may indicate related information to the media; the appearance of the ‘infospheres,’ or other icons, within that gallery may allow the user to determine the situational relevance of content represented by such icons, for example. Metadata associated with a piece of content may be viewable by rolling over the sphere or icon representing such content. For example, a metadata window may appear when a cursor is situated above or near an icon for a period of time.

Conversations taking place around the media may be represented in the gallery, as well as other information available to the user to enhance, move further into, away from or alongside the information currently being consumed by the user. By clicking on the comment, the player may be configured to filter suggested content to include content related to one or more of the following: The comment and other content with similar comments/content; the commenter and other content commented on by him or her, or their community; information the user's selected community or personalized filters have isolated as relevant at that time.

The information above may be viewable in multiple formats depending on the user's preference for consuming and selecting information. For example, information may be viewable as either a list or graphic interface. In certain embodiments, interfaces combine aspects of multiple searches and filtration to produce Infospheres' whose appearance communicates situational relevance to the user. Situational relevance may refer to the current physical needs or wants of the user. For example, should the user be interested in dinner in a strange city, he may be able to access a map populated by spheres of eating opportunities filtered in any number of customizable ways, such as by location.

In certain embodiments, selecting a piece of information would ‘put it into the system,’ where the users filters may be configured to rescramble or adjust to revise the information. Furthermore, connections and communities related to the new media, and how it relates to previously consumed information, may be formed.

Each consumption, or failure to consume, may allow for more accurate niche filtration and identification of personally relevant info. This may help create a ‘personal preference’ map (i.e., profile) that can quickly identify information that will be relevant to a user in a given location or given time. Consumption may be measured by time, connected by related searches and related searchers and their conversations or filtrations preferences.

Information may be used when the user wishes to be a ‘consumer.’ For example, the filtered information may be used, in certain embodiments, to provide access to products, events, and media that have been pre-screened (i.e., filtered) to determine personal relevance. In certain embodiments, brands the user has trust with, or has need for their information may be ‘allowed’ into their gallery, the adds themselves becoming more or less visible depending on the information consumed at the time.

### Second-Screen Sync

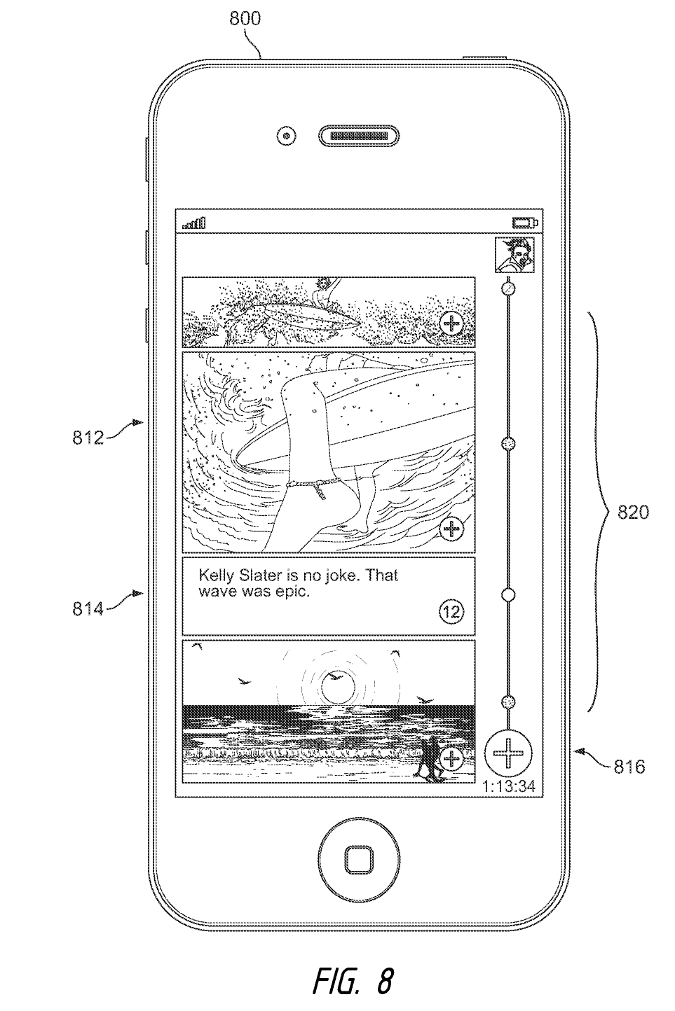

FIG. 8 illustrates a user interface displayed on a mobile computing device in accordance with one or more embodiments. The application interface may correspond to a media syncing application, wherein a device, such as a mobile computing device, is synced with media playing on a separate device. For example, a user may be able to sync a mobile phone or other mobile device to a TV or other presentation of media, such that the timeline 820 of the interface is substantially synchronous with a play time associated with the presented media. When in sync, the user may be able to use the mobile device 800 to interact with the media, wherein input by the user becomes associated with the media such that the user's contribution to the media is stored in the system and accessible by other users.

The timeline 820 may advance in some manner to track the play time of the presented media. In certain embodiments, the user interface may present content contributed by other users as the media advances, including, for example, images 812, text 813, or the like. The interface may further include an icon 816 or other functionality for selection by the user, thereby initiating a user interaction process.

Dots or other icons on the timeline 820 may represent different types of media on video playback on the mobile device 800. In certain embodiments, the application demonstrated by the interface of FIG. 8 may allow for a user to view a video on a video-hosting website, such as YouTube, on one screen and interact with the video audience in real-time on the mobile device 800 by Tweeting, commenting, and/or adding photos.

### Media Profile

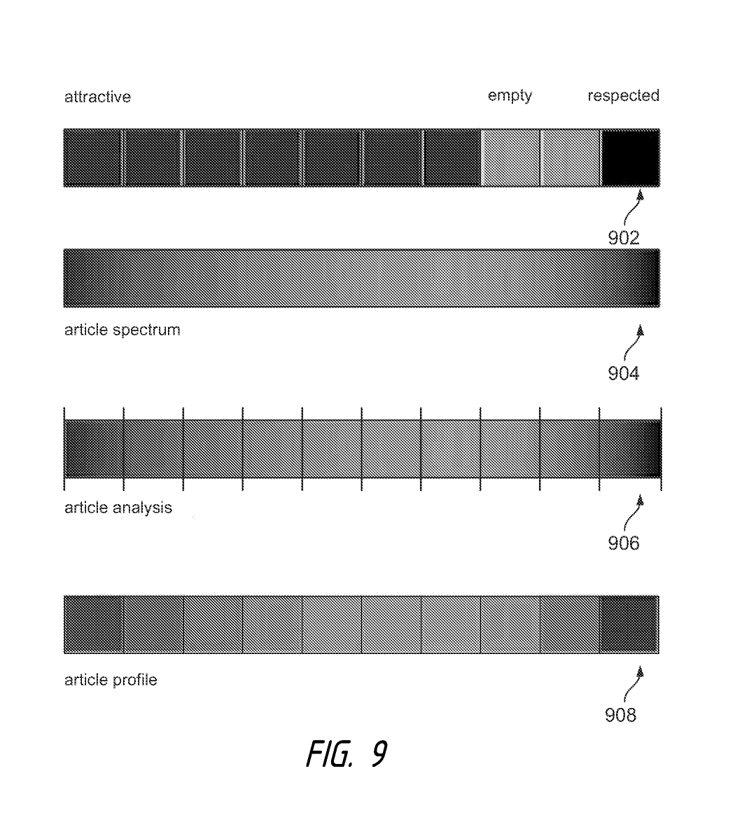

Certain embodiments described herein provide for representation of media content and/or other types of content, or collections thereof, using a spectrum that defines characteristics of the content. For example, in certain embodiments, different content characteristics may be represented by different colors on a color spectrum. Media content associated with such traits may therefore be represented using a spectrum of colors represented by the traits. FIG. 9 provides example media content profiles based on a color spectrum according to some embodiments. The embodiments of FIG. 9 may be understood with reference to the following example. In an embodiment, a news article is analyzed for the purpose of generating a characteristic color profile that provides a visual representation of at least some of the contents of the article. Analysis of the article may be performed in any suitable manner, wherein results of the analysis provide characteristics of the article. The characteristics may be weighted to indicate the degree to which particular traits/characteristics are embodied in the analyzed content.

In certain embodiments, analytical characteristics are related to human emotions, attitudes, perspectives, preferences, propensities, and/or the like. Characteristics/traits may further relate to other demographic, geographic, temporal, or other types of characteristics. In certain embodiments, each analyzed characteristic, or subsets of characteristics, is associated with a point or region of the utilized spectrum (e.g., color spectrum).

The system may be configured to analyze digital content to associate the content, or portions thereof, with the characteristics/traits with upon which the analysis is based at least in part. In an embodiment, keyword searching may be performed, wherein certain keyword(s) are associated with characteristics; when a keyword is found in text, the characteristic associated with such keyword may be then associated with the text. With further reference to the example above, the text of the article may be scanned to locate relevant keywords. As shown in FIG. 9, the spectrum profile 902 includes seven boxes colored a first color (e.g., red) associated with the trait “attractive,” while two boxes are associated with the trait “empty,” and one with the trait “respected.”

The profile may result from a scanning of the article text that reveals seven keywords related to “attractive,” two keywords related to “empty” and one keyword related to “respected.” In certain embodiments, the boxes do not represent a one-to-one correspondence between keywords and boxes, but represent a ratio of traits. For example, the weighted relevance of “attractive” may correspond to a 7/10 ratio with respect to other traits. This ratio may be represented in any suitable manner. For example, each of the profiles of FIG. 9 represents different possible types of representations of the profile spectrums. As shown, the profile 904 represents the ratio of traits in a substantially continuous blending of colors. The other profiles 906, 908 provide additional examples of blended color representation.

While certain figures and embodiments are described herein in the context of color spectrums and/or other color-based digital content representation, other non-textual or textual modifiers may be implemented to achieve the functionality described herein. For example, shape, animation, or other features may be used along with, or in place of, color representation. In certain embodiments, the spectrum, or content profile, is generated using available colors and compared to other media to find a match based on number of similar colors in the profiles. Each profile may be constructed of, for example, 10 color swatches.

With further reference to the example introduced above, the news article analyzed may include keywords associated with the traits “attractive,” “empty,” and “respected.” In addition, the respective traits may be associated with certain colors/shades or other visual features. Table B provides examples of certain characteristics/keywords/colors associations that may be used in a media profiling system, as relating to the above-referenced example.

TABLE B

| Trait | Color | Keywords |
|---|---|---|
| attractive | f04f37 | adorable, agreeable, alluring, beautiful, |
| | | captivating, charming, enchanting, enticing, fair, |
| | | fascinating, glamorous, good-looking, |
| | | gorgeous, handsome |
| empty | 71c167 | abandoned, bare, barren, blank, dead, |
| | | depleted, desert, deserted, destitute, evacuated, |
| | | exhausted, forsaken |
| respected | c14298 | admired, appreciated, beloved, important, |
| | | valued |

Lists of keywords associated with terms may include more or fewer keywords than those shown in Table B. Furthermore, the system may be configured to perform analysis based on any number of traits, and using any desirable or practical trait, color code and/or keyword combinations.

In certain embodiments, a particular trait is not recognized as a contributing trait until a threshold number of occurrences of associated keywords are identified. Furthermore, as shown in the examples of FIG. 9, a content profile may only display a certain number of traits or fewer. For example, in certain embodiments, only the top three traits by weighted relevance are presented as part of the profile. In certain embodiments, the traits are presented in order based on weighted relevance. For example, more significant traits may be presented on the left of the profile bar, and move to the right in order.

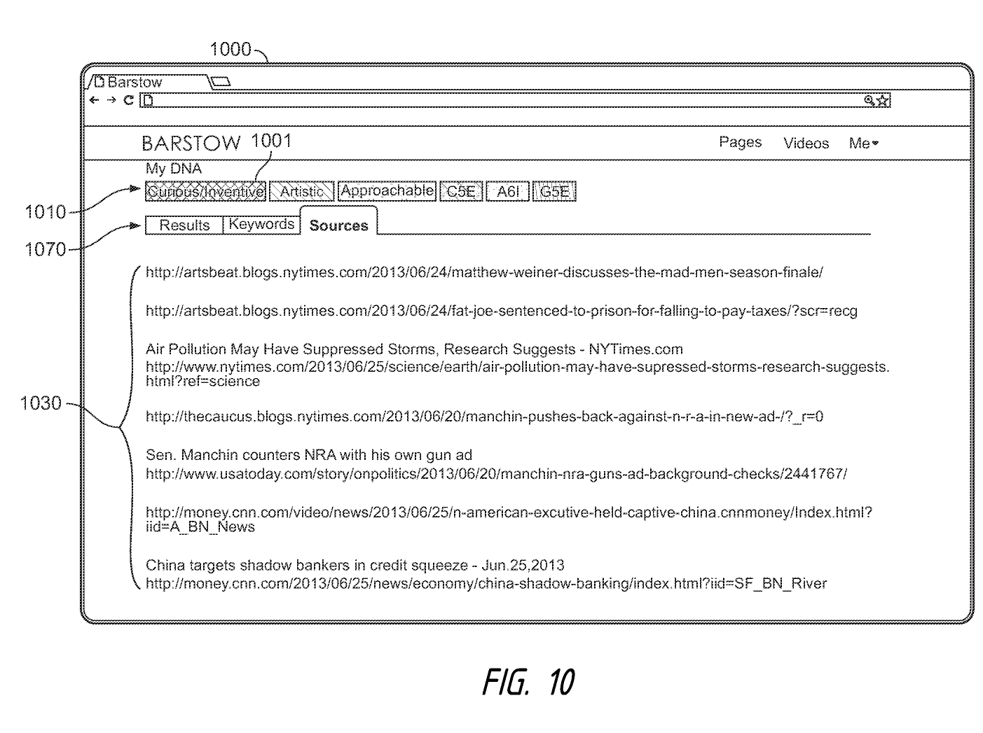

FIG. 10 illustrates a user interface incorporating profile representation according to an embodiment. In certain embodiments, a user profile is generated based on information associated with the user, wherein the user profile is represented in a similar manner to the profiles described above. For example, characteristics or traits deemed to be associated with a user may be presented as color and/or text as part of a visual profile.

The user interface 1000 includes a personal profile bar 1010, which illustrates weighted traits of the user. The determination of user traits may be based on any user profile information. In certain embodiments, the user maintains a profile with the system, which may be a website or downloadable software application, and may be accessible using any type of computer, such as a desktop or mobile device. The user may introduce into the system content on which the user's profile may be based. For example, in an embodiment, the user imports articles or other media content, or links thereto or other representations thereof, into the user's profile. The system may analyze the imported content and impute characteristics of the content to the user in generating the user profile. As shown, the UI 1000 includes tabs 1070, including a tab for sources, which displays references 1030 to the content that at least partially forms the basis of the user's profile. Other types of information may also be used, such as inputted biographical, demographic, preference, or other user information. Furthermore, the system may be configured to passively glean information related to the user from user online behavior, location (e.g., using the GPS functionality of a mobile device), or the like. In certain embodiments, the user may enter characteristics/traits directly. For example, the UI 1000 may allow for the user to input a current emotional state or the like, wherein the user's profile will be modified, perhaps only temporarily, to reflect such current emotional state.

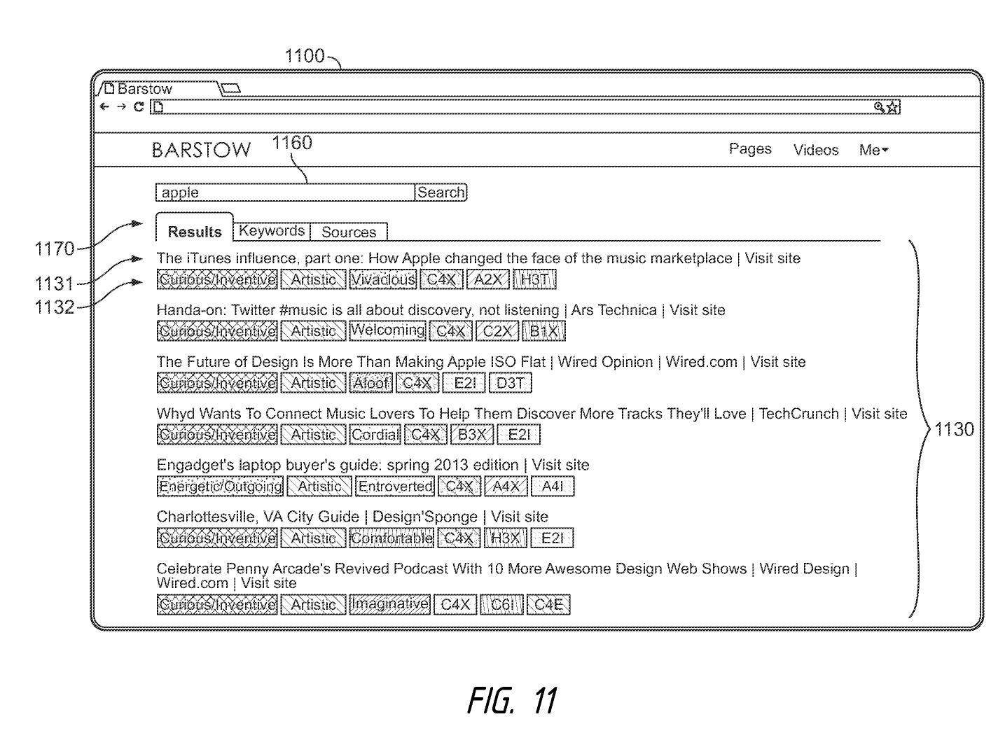

FIG. 11 shows a user interface (UI) 1100 that provides profile-based Internet-searching functionality. The UI 1100 includes an Internet search bar 1170 including a text box for entering search terms. The tabs 1170 include a tab for search results 1130, which may be listed, as shown, or provided in a results gallery, as described herein. The search results 1130 may have been analyzed by the system to determine content profiles, such as the profile bar 1132 illustrated in association with the first listed reference. Search results may include a title (e.g., 1131) in addition to a content profile representation (e.g., 1132). The search results may be filtered to promote results that have profiles determined to be most similar to the user's profile. For example, certain algorithms may be utilized to determine which results share characteristics most closely, or relatively closely, with the user's profile.

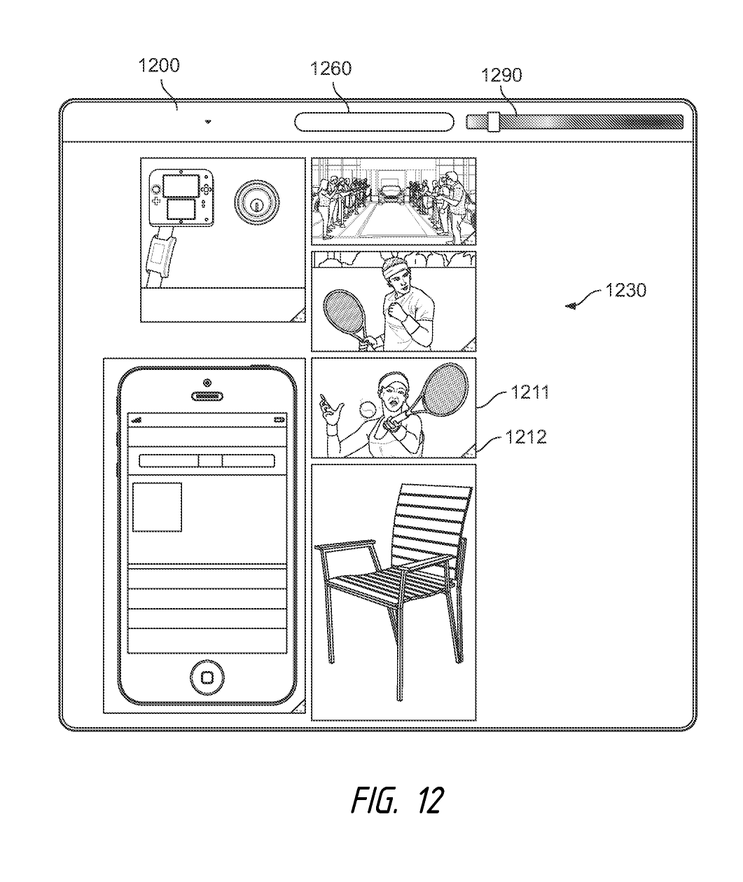

In certain embodiments, search results or other content may be presented using images, such as thumbnail images, or other types of images. FIG. 12 illustrates a user interface providing image-based search result presentation. The UI 1200 includes a search box 1260, wherein a user may enter search terms for searching content available over the Internet. In certain embodiments, each piece of content is represented by one or more images 1230 in a viewing gallery. The search results may be filtered according to their content profiles, as described above. Furthermore, images/icons representative of content items (e.g., 1211) may include a color or other non-textual (or textual) designation 1212 indicating characteristics of the represented content. The UI 1200 may include a slider object 1290 for reorganizing the gallery contents. In certain embodiments, as the slider is moved from one color region to another, the results may be reorganized to focus on items sharing color characterization with the position of the slider 1290.

### Digital Personality Variables

In order to more precisely identify information of relevance to a user, a ‘digital’ personality or infosphere may allow for non-‘personal’ data to be a reflection of a person or group of people. Such data may be utilized to fine-tune information aggregation.

### Music Profile

Music can be an indicator of a myriad of personal characteristics (e.g., year of birth, geographic location, geographic history, social class or expectation, political leanings and/or other characteristics). Embodiments disclosed herein provide for input of music preference data into a system database, wherein such information is used to determine user interests. For example, the music collection of a group, demographic, population, etc. may be compiled into a viewable graphical interface. Many users maintain at least a portion of their music libraries online, thus allowing for comparison of this music data across multiple criteria just like the viewing galleries described above.

In certain embodiments, a user's music library is effectively compressed into a single digital file, such as a .WAV file. This digital music file may be substantially specific, and may be used to determine a number of likely information paths and areas of interest for the user. Furthermore, access to the user's music library may present relatively low security/privacy risk with respect to ‘personal’ information relative to certain other user interest-type data. Therefore, a user may be more inclined to volunteer music data than certain other types of personal data, thereby possibly improving or expediting data collection. In certain embodiments, the digital music library file may be considered analogous to a fingerprint; the library file may be compared to system content and/or other music library files based on similarity to and/or variation from each other.

### Dating Site

A dating site implementing certain features disclosed herein may not require a lengthy, or otherwise cumbersome, survey to determine possible ‘matches’ for a user. For example, in certain embodiments, a user may simply select a gradient: a person could select to view profiles (e.g., as infospheres) of people within a 20% compatibility of their ‘musical profile,’ within 10 miles of their home, with brown hair, etc. In certain embodiments percentage variation relates to, for example, bit-level data variance between data files or other interest/profile data. Such an esoteric filter, combined with the subtle but potentially powerful ‘I Ching’ aspect of the animated icons may enhance the user experience considerably.

Similar-type profiles may exist for any number of personal history quotients, such as, for example, one or more of the following: places you have been; books you have read; social media communities; content you or others have consumed; or any number of other variables. The overlay of multiple expanding levels of filtration may allow the computer interface to work, to some degree, in a similar manner as the human brain, pushing aside information that is not of immediate importance, and allowing the strength of our personal conscious and free access to the most relevant information at the time. Certain embodiments implement artificial neural network technology to more closely mimic function of the human brain.

By allowing the user to view multiple layers of relevant or related information, he or she may be able to select information based on a variety of visual criteria that represents actual data. The uniqueness of the user's choices, as well as his or her ability to identify patterns and interpret spheres that represent relevant information may provide an improved searching experience. Because each individual sphere may not be necessarily read to process its content, an element of controlled coincidence or surprise within a given context may be provided. Proximity to something the user knows, or is familiar with, may moderate the user's expectation of information.

In certain embodiments, filtering based on socio-economic factors is at least partially inherent in one or more of the filtration processes/mechanisms discussed above. When the data is combined with purchase profiles and commercially related data, patterns of consumption can become apparent and products or services relevant to a particular group can be offered with relatively less friction.

### System Architecture

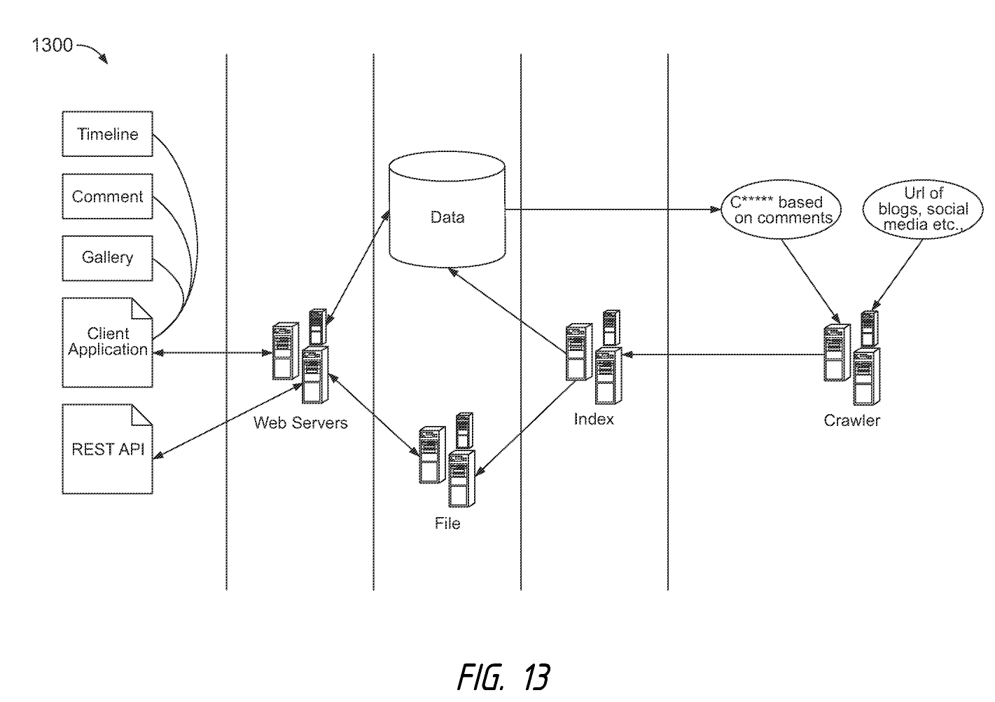

FIG. 13 illustrates a computing system in accordance with one or more embodiments disclosed herein. Certain embodiments may consist of a client/server architecture. Users may interface with the system through the client. For example, the client may be using web browsers with focus on HTML5 and/or fallback using Adobe Flash. The client may also interact with the server through a REST API, or other API.

The backend of the system 1300 may consist of one or more servers, such as, for example: (1) database servers using, e.g., MySQL, which may store such information as comments, referenced media, and/or cached information index by the index server; (2) file servers may act as storage for image, media, associated with a comment; (3) web servers using, e.g., Apache on a Linux based OS. User pages may be served with a combination of php and/or custom c++ application. Such servers may also deliver the output requested by the REST API; (4) index/crawler servers consisting of one or more databases of, for example, MySQL and/or custom scripts and/or software using php and/or c++ to index and/or crawl. The crawler may crawl predefined sites for relevant information. The index server may organize and/or filter out the crawled information to determine content relevance.

Certain embodiments may involve content associated with web conversations, so comments and/or associated data may be utilized in certain embodiments. These comments may at least partially define what the crawler crawls and/or the indexer indexes. A cache may be stored of links, comments, and/or other metadata created by the indexer. User data may also be stored, along with metadata that may help define their user profiles. These profiles may also be used to set parameters for the crawler and/or indexer. In certain embodiments, users may be authenticated using, for example, third party Open ID affiliates.

### Software Modules

Computer-executable code that, when executed, causes one or more processors to at least partially implement functionality associated with one or more embodiments herein may include some of the features described below. Software modules may be substantially separate to allow them to be used universally and/or globally. They may work individually and/or as a group with data supplied by the system.

Comment Module

The comment module may provide functionality that allows a user to input an attached/uploaded piece of content (e.g., image, video, links, etc . . . ), a text comment, and/or a color submit button. Using one or more of html, JavaScript, Ajax, or the like, the input may be stored in the database. This comment interface may be created as a plugin, such as a browser extension, so that it can be used on various websites, with relatively minimal integration. An option to share with other media sites may allow the comment to be posted along with a link back to the system. The REST API may allow the comments being stored to be referenced externally.

Timeline Module

As described above, the timeline module may provide an interface that allows video or audio content to be advanced to a certain position in the content. Comments may be displayed on, or in connection with, this timeline based on the reference time of the content that is associated with the comment. An iconic thumbnail of the comment may allow a user to click on it to display the comment in much detail in a separate dialog box. As the content is playing, the scrub line may display the comment marked at that specific point in time in a display area above the timeline. Multiple comments may be displayed so that the user may not miss any.

The timeline may also contain a color bar that represents either average colors defined by comments for that point in time, or a color histogram of that frame for that point in time. The timeline module may make use of the comment module to get input for the user. The timeline module may allow a queue so that the user may comment without any interruption of the playing video. In certain embodiments, events such as clicks, start, ended, commented may be bindable. The timeline may be developed with html, JavaScript, Ajax, or the like.

Gallery Module

The gallery may be a visual interface for displaying comments or other content. The display may have sphere-shaped icons with colors and/or movements that communicate certain attributes of the content represented by the icon, such as time, priority, location, and/or origin. Icon animation may help define relationships, for example.

In certain embodiments, filters may allow for presentation of a particular subset of available information. For example, filters may consist of time, location, etc. In certain embodiments, content icons may be clickable to be viewed in detail.

Input to the gallery module may comprise an array of data in a .json format to be displayed. Certain embodiments may provide data indexed by the index server related to the content (e.g., video) and/or real-time data from certain sites (i.e. twitter) based on criteria similar to that utilized by the crawler. Events, such as spheres being selected, may be bindable.

The gallery may be developed using HTML5 (canvas), JavaScript, Ajax, and or the like. In an embodiment, the gallery may be developed using Adobe Flash.

Crawler/Indexer Module(s)

Certain embodiments may define a set of URL's to crawl and/or search for certain information related to comments. After the data is collected from the crawler, the indexer may organize and/or cache the data for fast lookup. In certain embodiments, a combination of php and/or c++ may be used to make custom software for crawling and/or indexing.

### Operation—User Types

Certain embodiments disclosed herein may provide for various operational user types. For example, system administrators may be considered super users that have authority to CRUD all data. Moderators may be configured to help ban, create, and/or delete users and/or content. Users may have the ability to comment and/or create content.

### Third-Party Dependencies

In certain embodiments, YouTube may be used for hosting videos content in the system, wherein the embodiments disclosed herein provide for commenting on such content. In addition, Adobe Flash technology may be utilized for timeline or other technologies in certain embodiments.

### Additional Embodiments

The various illustrative logical blocks, modules, data structures, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like. A processor may also be implemented as a combination of computing devices—for example, a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, a hard disk, a removable disk, a CD-ROM, memory capable of storing firmware, or any other form of computer-readable storage medium. An exemplary computer-readable storage medium can be coupled to a processor such that the processor can read information from, and write information to, the computer readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Reference throughout this specification to “certain embodiments,” “some embodiments,” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

A number of applications, publications, and external documents may be incorporated by reference herein. Any conflict or contradiction between a statement in the body text of this specification and a statement in any of the incorporated documents is to be resolved in favor of the statement in the body text.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments of the inventions described herein may be embodied within a form that does not provide all of the features and benefits set forth herein, as some features may be used or practiced separately from others.

What is claimed is:

1. A system for presenting digital content items to a user, the system comprising:
one or more data storage devices configured to store metadata associated with a plurality of user comment items and profile information associated with a first user;
one or more processors in communication with said one or more data storage devices, the one or more processors programmed to:
generate a user interface including a video media presentation window and a comment display gallery;
receive a request from the first user to view a video content item;
display the video content item in the media presentation window;
select a subset of the plurality of user comment items based at least in part on the metadata associated with the plurality of user comment items and the profile information associated with the first user, the subset of user comment items being associated with the video content item;
generate a plurality of digital icons, each of the plurality of digital icons being associated with one of the selected subset of user comment items; and
display the plurality of digital icons in the comment display gallery;
wherein the plurality of digital icons have color features that indicate characteristics of text of the user comment items with which they are associated.

2. The system of claim 1, wherein the one or more processors are programmed to communicate characteristics of the text of the user comment items at least in part by animating the digital icons, wherein the digital icons have shape features that indicate characteristics of the text of the user comment items with which they are associated.

3. The system of claim 1, wherein the digital icons are spherically-shaped animated icons.

4. The system of claim 1, wherein the plurality of digital icons comprise substantially no text.

5. The system of claim 1, wherein the profile information includes information associated with a music library of the first user.

6. A computer-implemented method of presenting digital content items to a user, the method comprising:
receiving a request from a first user to view a video content item;
generating a user interface including a video media presentation window and a comment display gallery;
displaying the video content item in the media presentation window;
selecting a plurality of user comment items associated with the video content item;
generating a plurality of digital icons, each of the plurality of digital icons being associated with one of the selected plurality of user comment items; and
displaying the plurality of digital icons in the comment display gallery;
wherein the plurality of digital icons have color features that indicate characteristics of text of the user comment items with which they are associated;
wherein the method is performed by one or more processors of a computing system.

7. The method of claim 5, wherein selecting the plurality of user comment items is based at least in part on profile information associated with the first user.

8. The method of claim 5, further comprising:
receiving a selection from the first user of a digital icon associated with a first comment submitted by a second user; and
in response to receiving the selection, displaying links to one or more additional digital content items that the second user has commented on.

9. The method of claim 7, further comprising:
displaying at least one of the one or more additional digital content items in the media presentation window.

10. The method of claim 5, further comprising:
displaying a first temporal portion of the video content item in the media presentation window, the first temporal portion being associated with a first user comment; and
enlarging a first digital icon of the plurality of digital icons associated with the first user comment substantially simultaneously with displaying the first temporal portion of the video content item.

11. The method of claim 5, wherein the user interface includes a color spectrum bar configured to allow a user to select a portion of the color spectrum bar, thereby associating a user comment with the a color represented by the portion of the color spectrum bar.

12. A computer-implemented method of presenting content items to a user, the method comprising:
receiving a request from a first user to view digital content items;
selecting a plurality of digital content items based at least in part on the request from the first user;
generating a plurality of digital icons, each of the plurality of digital icons being associated with one of the plurality of digital content items; and
presenting the plurality of digital content items to the first user using a user interface;
wherein the plurality of digital icons have color features that indicate characteristics of the digital content items with which they are associated;
wherein the method is performed by one or more processors of a computing system.

13. The method of claim 1, further comprising receiving from the first user a request to filter content results to reflect preferences of a predefined peer group, wherein selecting the plurality of digital content items is based at least in part on the preferences of the predefined peer group.

14. The method of claim 1, further comprising receiving from the first user a request to filter content results to include results having a connection to a particular geographic region, wherein selecting the plurality of digital content items is based at least in part on the geographic region.

15. The method of claim 1, wherein the digital content items comprise user comment items associated with a digital content item that the first user has indicated a desire to view;

16. The method of claim 1, wherein the plurality of digital icons have size features that indicate characteristics of the digital content items with which they are associated.

17. The method of claim 1, wherein the plurality of digital icons have shape features that indicate characteristics of the digital content items with which they are associated.

18. The method of claim 1, further comprising animating the plurality of digital content items, wherein animation features of the digital content items indicate characteristics of the digital content items.

19. The method of claim 1, wherein the plurality of digital icons comprise spheres.

20. The method of claim 9, wherein the plurality of digital icons comprise a sphere of a first color with a ring of a second color around the sphere.
